(19) United States
(12) Patent Application Publication
(10) Pub. No.: US 2017/0349862 A1
(43) Pub. Date: Dec. 7, 2017

(54) USE OF INORGANIC OXIDES, HYDROXIDES OR OXYHYDROXIDES IN ENZYME-CONTAINING DETERGENTS OR CLEANING AGENTS IN ORDER TO INCREASE ENZYME STABILITY

(71) Applicant: Henkel AG & Co. KGaA, Duesseldorf (DE)

(72) Inventors: Hendrik Hellmuth, Darmstadt (DE); Claudia Lindner, Solingen (DE); Timothy O'Connell, Landsberg am Lech (DE); Christian Kropf, Hilden (DE); Christian Umbreit, Neuss (DE)

(73) Assignee: Henkel AG & Co. KGaA, Duesseldorf (DE)

(21) Appl. No.: 15/536,744

(22) PCT Filed: Dec. 1, 2015
(86) PCT No.: PCT/EP2015/078130

§ 371 Date: Jun. 16, 2017

(30) Foreign Application Priority Data
Dec. 17, 2014 (DE) 102014226251.8

(51) Int. Cl. C11D 3/386; C11D 3/20; C11D 3/12

(52) U.S. Cl. CPC C11D 3/38663; C12Y 304/21062; C11D 3/1213; C11D 3/2086

(57) ABSTRACT

The disclosure relates to the use of inorganic oxides, hydroxides or oxyhydroxides in enzyme-containing detergents or cleaning agents in order to increase enzyme stability as well as to an enzyme-containing detergent or cleaning agent, in particular a liquid detergent or cleaning agent having greater enzyme stability.

### CROSS-REFERENCE TO RELATED APPLICATIONS

This application is a U.S. National-Stage entry under 35 U.S.C. §371 based on International Application No. PCT/EP2015/078130, filed Dec. 1, 2015, which was published under PCT Article 21(2) and which claims priority to German Application No. 10 2014 226 251.8, filed Dec. 17, 2014, which are all hereby incorporated in their entirety by reference.

### TECHNICAL FIELD

The disclosure relates to the use of inorganic oxides, hydroxides or oxide hydroxides in enzyme-containing washing or cleaning agents to increase the stability of enzymes, and to an enzyme-containing washing or cleaning agent, in particular a liquid washing or cleaning agent having improved enzyme stability.

### BACKGROUND

Conventional washing or cleaning agents available in the market contain surfactants to remove dirt and stains. In general, combinations of multiple surfactants, and in particular from the group of the anionic, non-ionic, cationic and amphoteric surfactants, are used. On their own, these surfactants are frequently not able to sufficiently remove dirt and stains, so that further auxiliaries are used in modern washing or cleaning agents. These further auxiliaries include enzymes of various types, such as proteases, amylases, cellulases, mannanases and pectate lyases. Additional enzyme classes are known to a person skilled in the art. In particular, hydrolytic enzymes such as proteases, amylases or lipases are integral parts of numerous textile washing agents or dishwashing detergents due to the direct cleaning action thereof. In addition to the enzyme structure, the enzymes used in washing or cleaning agents to achieve the cleaning action crucial for the end user are, to a significant degree, also determined by the type of the formulation of these enzymes and the stabilization of these against environmental conditions.

Enzymes providing washing or cleaning action are formulated both in solid form and in liquid form. The group of solid enzyme preparations includes, in particular, the enzyme granules composed of multiple ingredients, which, in turn, are preferably incorporated into solid washing or cleaning agents. Liquid or gel washing or cleaning agents, in contrast, frequently include liquid enzyme preparations, wherein these, unlike the enzyme granules, are far less protected against external influences.

A number of different protective measures have been proposed to increase the stability of such enzyme-containing liquid washing or cleaning agents. The German patent application DE 20 38 103 (Henkel), for example, teaches the stabilization of enzyme-containing dishwasher detergents by way of saccharides, while the European patent EP 646 170 B1 (Procter & Gamble) teaches propylene glycol to stabilize enzymes in liquid cleaning agents.

Polyols, and in particular glycerol and 1,2-propylene glycol, are described in the prior art as reversible protease inhibitors. A corresponding technical disclosure can be found in the international application WO 02/08398 A2 (Genencor), for example.

The stabilization of enzymes in aqueous cleaning agents by way of calcium salts, such as calcium formate, calcium acetate or calcium propionate, is described by U.S. Pat. No. 4,318,818 (Procter & Gamble). Salts of polyvalent cations, such as calcium cations, however, frequently cause turbidity in aqueous systems, and in particular in manual dishwashing agents, during storage. This negative effect is intensified when these agents are stored at low temperatures. The possible usage concentrations are thus limited, so that no sufficient enzyme-stabilizing action can be ensured.

Borax, boric acids, boronic acids or the salts or esters thereof form a second group of known stabilizers. Among these, above all derivatives with aromatic groups, such as ortho-, meta- or para-substituted phenylboronic acids, shall be mentioned, and in particular 4-formylphenylboronic acid (4-FPBA), or the salts or esters of the aforementioned compounds. The latter compounds, serving as enzyme stabilizers, are disclosed in international patent application WO 96/41859 A1 (Novo Nordisk), for example. Boric acids and boric acid derivatives, however, often have the disadvantage, for example, that these form undesirable by-products with other ingredients of a composition, and in particular washing or cleaning agent ingredients, whereby these are no longer available for the desired cleaning purpose in the particular agents, or even remain on the items being washed or cleaned as stains. Furthermore, boric acids or borates are considered to be disadvantageous from environmental aspects.

### BRIEF SUMMARY

An enzyme-containing washing or cleaning agent is provided herein. The agent includes inorganic oxides, hydroxides or oxide hydroxides. The inorganic oxides, hydroxides or oxide hydroxides are utilized to increase the stability of enzymes.

Another enzyme-containing washing or cleaning agent is provided herein. The agent includes enzymes stabilized by inorganic oxides, hydroxides or oxide hydroxides.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

It is thus the object of the present disclosure to provide a stabilizing agent for enzymes which avoids the disadvantages of the state of the art as much as possible.

Surprisingly, it was found that inorganic oxides, hydroxides or oxide hydroxides, in enzyme-containing washing or cleaning agents, can cause a considerable increase in the stability of the present enzymes.

The subject matter as contemplated herein is thus the use of inorganic oxides, hydroxides or oxide hydroxides in enzyme-containing washing or cleaning agents to increase the stability of enzymes.

It is preferred if the washing or cleaning agent is a liquid washing or cleaning agent, and preferably an aqueous, liquid washing or cleaning agent.

The enzyme is preferably a protease, and in particular a subtilisin.

As contemplated herein, liquid agents shall be understood to mean agents that, under normal usage conditions, are flowable and have viscosities that can vary within a broad range. The liquid preparations also include gel or pasty agents, which, if necessary, can comprise additional thickeners known from the prior art. In a further preferred embodiment as contemplated herein, the liquid agents are water-based, wherein the agents can also comprise fractions of organic solvents. A person skilled in the art knows appropriate organic solvents that can be used in liquid, aqueous washing or cleaning agents from the literature.

Advantageously, it has been found that inorganic oxides, hydroxides or oxide hydroxides contribute to the stabilization of enzymes already in relatively low amounts. In a preferred embodiment as contemplated herein, an agent is thus provided which comprises inorganic oxides, hydroxides or oxide hydroxides in amounts of up to about 5 wt. %, and preferably of from about 0.01 wt. % to about 5 wt. %. In particular, agents are preferred which comprise inorganic oxides, hydroxides or oxide hydroxides in amounts of from about 0.01 wt. % to about 2.5 wt. %, and further preferably of from about 0.7 to about 1.4 wt. %.

The binding of the enzymes to the inorganic oxides, hydroxides or oxide hydroxides is likely essentially based on electrostatic interactions. Advantageous inorganic oxides, hydroxides or oxide hydroxides are those that carry a surface charge opposite to the charge of the enzyme at the pH value of the agent. A further considerable advantage as contemplated herein is thus that the enzymes stabilized as contemplated herein can be deliberately released by changing the ion concentration and/or the pH value.

An agent as contemplated herein comprises at least one enzyme from the group of the known enzymes usually used in washing or cleaning agents. In a preferred embodiment as contemplated herein, an agent as contemplated herein comprises at least one protease, and particularly preferably at least one protease and at least one amylase.

All proteases known from the prior art are suitable proteases. Among these, those of the subtilisin type are preferred. Examples of these are the subtilisins BPN′ and Carlsberg and the further developed forms thereof, the protease PB92, the subtilisins 147 and 309, the alkaline protease from Bacillus lentus (BLAP), subtilisin DY and the thermitase and proteinase K enzymes, which can be assigned to the subtilases, but not to the subtilisins in the narrower sense, and the proteases TW3 and TW7. The protease is particularly preferably a subtilisin of the BLAP type.

Subtilisin BPN′, which is obtained from Bacillus amyloliquefaciens or B. subtilis, is known from the works of Vasantha et al. (1984) in J. Bacteriol., Volume 159, pp. 811-819 and J. A. Wells et al. (1983) in Nucleic Acids Research, Volume 11, pp. 7911-7925. Subtilisin BPN′ is used, in particular, as a reference enzyme of the subtilisins regarding the numbering of the positions. Subtilisin Carlsberg is available in further developed form under the trade name Alcalase® from Novozymes A/S, Bagsvaerd, Denmark. It is described in the publications by E. L. Smith et al. (1968) in J. Biol. Chem., Volume 243, pp. 2184-2191, and by Jacobs et al. (1985) in Nucl. Acids Res., Volume 13, pp. 8913-8926 and formed naturally by Bacillus licheniformis. The protease PB92 is produced naturally by the alkaliphilic bacterium Bacillus nov. spec. 92 and available under the trade name Maxacal® from Gist-Brocades, Delft, Netherlands. It is described in the original sequence thereof in patent application EP 283075 A2. The subtilisins 147 and 309 are sold under the trade names Esperase® and Savinase® by Novozymes. They were originally obtained from bacillus strains disclosed in application GB 1243784 A. The variants sold under the designation BLAP® are derived from the protease from Bacillus lentus DSM 5483 (WO 91/02792 A1), which are described, in particular, in WO 92/21760 A1, WO 95/23221 A1, WO 02/088340 A2 and WO 03/038082 A2. Subtilisin DY was originally described by Nedkov et al. 1985 in Biol. Chem Hoppe-Seyler, Volume 366, pp. 421-430. Further proteases that may be used are, for example, the enzymes available under the trade names Durazym®, Relase®, Everlase®, Nafizym, Natalase®, Kannase® and Ovozyme® from Novozymes, under the trade names Purafect®, Purafect® OxP, Purafect® Prime and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

The proteases used in the agents as contemplated herein are either originally obtained from microorganisms, for example microorganisms of the genus Bacillus, Streptomyces, Humicola or Pseudomonas, and/or are produced according to biotechnology methods that are known per se using suitable microorganisms, for example using transgenic expression hosts of the Bacillus genus or using filamentous fungi.

Synonymous terms can be used for amylases, such as 1,4-alpha-D-glucan-glucanohydrolase or glycogenase. Amylases that can be formulated as contemplated herein are preferably α-amylases. The decisive factor as to whether an enzyme is an α-amylase within the meaning as contemplated herein is the capability thereof to carry out the hydrolysis of α(1,4)-glycosidic linkages in the amylose of the starch.

Amylases that can be formulated as contemplated herein are, for example, the α-amylases from Bacillus licheniformis, from Bacillus amyloliquefaciens or from Bacillus stearothermophilus, and, in particular, also the further developments thereof which have been improved for the use in washing or cleaning agents. The enzyme from Bacillus licheniformis is available from Novozymes by the name Termamyl® and from Danisco/Genencor by the name Purastar® ST.

Further development products of this α-amylase are available from Novozymes under the trade names Duramyl® and Termamyl® ultra, from Danisco/Genencor by the name Purastar® OxAm, and from Daiwa Seiko Inc., Tokyo, Japan, as Keistase®. The α-amylase from Bacillus amyloliquefaciens is sold by Novozymes by the name BAN®, and derived variants of the α-amylase from Bacillus stearothermophilus are available by the names BSG® and Novamyl®, likewise from Novozymes. For this purpose, furthermore the α-amylase from Bacillus sp. A 7-7 (DSM 12368) and the cyclodextrin glucanotransferase (CGTase) from Bacillus agaradherens (DSM 9948) shall be emphasized. Likewise, it is possible to use fusion products of all aforementioned molecules. Furthermore, the further developments of the α-amylase from Aspergillus niger and A. oryzae available from Novozymes under the trade name Fungamyl® are suitable. Further commercial products that can advantageously be used are, for example the Amylase LT® and Stainzyme® or Stainzyme Ultra® or Stainzyme Plus®, the latter likewise being available from Novozymes. As contemplated herein, it is also possible to use variants of these enzymes obtained by way of point mutations. Particularly preferred amylases are disclosed in international unexamined patent applications WO 00/60060, WO 03/002711, WO 03/054177 and WO 07/079938, the disclosure of which is hereby expressly referenced, or the disclosure of which in this regard is expressly incorporated in the present patent application by reference.

Inorganic oxides, hydroxides or oxide hydroxides that are preferred as contemplated herein are oxides, hydroxides or oxide hydroxides of calcium, magnesium, aluminum, titanium, zirconium, yttrium or zinc, and in particular of aluminum. Aluminum oxide hydroxide (boehmite) is particularly preferred. Mixtures of these inorganic oxides, hydroxides or oxide hydroxides are likewise suitable as contemplated herein.

The particle size of these oxides, oxide hydroxides and hydroxides is preferably less than 500 nm (nanometers), wherein the value is based on the particle diameter in the longitudinal direction, which is to say in the direction of the larger extension of the particles. Such fine-particled oxides, oxide hydroxides or hydroxides can be produced according to known methods, such as according to EP 711 217 A1 (Nanophase Technologies Corp.). Suitable oxides are commercially available under the trademark Nano Tek®. Oxide hydroxides and hydroxides in a very fine distribution are also accessible by way of hydrolysis of organometallic compounds.

Oxides, oxide hydroxides and hydroxides having a particle size of less than about 200 nm, preferably of from about 1 to about 100 nm, and particularly preferably of from about 1 to about 50 nm, are particularly preferred as contemplated herein.

In a further preferred embodiment as contemplated herein, the inorganic oxides, hydroxides or oxide hydroxides (oxide hydrates) are surface-modified. Such surface-modified oxides, hydroxides or oxide hydroxides can be obtained, for example, by way of the method described in DE 19857235 A1, which is hereby included by reference in its entirety. Fine-particled oxides, oxide hydroxides or hydroxides of calcium, magnesium, aluminum, titanium, zirconium, yttrium or zinc, and preferably those having a particle size of less than about 200 nm, are treated with aqueous solutions of carboxylic acids or hydroxycarboxylic acids having 2 to 8 carbon atoms, and the resultant modified powders are dispersed in water or in aqueous preparations.

Suitable fine-particled oxides are, for example, magnesium oxide, aluminum oxide, titanium dioxide, zirconium dioxide and zinc oxide. Aluminum oxide hydrate (boehmite), for example, is an especially particularly suitable oxide hydroxide, and calcium hydroxide and aluminum hydroxide, for example, are suitable hydroxides.

One nanopowder that is particularly suitable for surface modification is an aluminum oxide hydroxide of the composition AlOOH.H2O (boehmite) having a specific surface area of more than 200 mg2/g. This material is available inexpensively in large quantities. The product is commercially available under the designation Disperal Sol P3 (Sasol).

All monobasic and multibasic carboxylic acids having 2 to 8 carbon atoms, which is to say, for example, acetic acid, propionic acid, oxalic acid, glutaric acid, maleic acid, succinic acid, phthalic acid, adipic acid and suberic acid, are suitable aqueous carboxylic acids for the surface modification of the oxide nanoparticles. Hydroxycarboxylic acids and fruit acids are preferably suitable, such as glycolic acid, lactic acid, citric acid, malic acid, tartaric acid and gluconic acid. A hydroxycarboxylic acid from the group consisting of lactic acid, citric acid, malic acid and tartaric acid is particularly preferred as the carboxylic acid.

The nanopowders are preferably treated with the aqueous solution of a carboxylic or hydroxycarboxylic acid such that the fine-particled oxides, oxide hydrates or hydroxides are treated with a solution of from about 0.01 to about 1 mole of the carboxylic acid per mole of the oxide, oxide hydrate or hydroxide. This treatment preferably takes place over a time period of from about 1 to about 24 hours at a temperature of at least 20° C.; preferably, however, it takes place at the boiling temperature of the water at normal pressure (100° C.). When pressure is used, the treatment can also take place at temperatures above 100° C. during an accordingly shorter time period.

The treatment with the carboxylic acids or hydroxycarboxylic acids modifies the surface of the oxide or hydroxy nanoparticles.

The modified metal oxides, oxide hydrates or hydroxides can be used either in the form of the aqueous dispersion obtained during the treatment with carboxylic acids or after prior isolation for the immobilization of enzymes.

The modified metal oxide, oxide hydrate or hydroxide powder is preferably isolated from the reaction mixture by way of dehydration. For this purpose, the dispersion is subjected to lyophilization, for example. The solvent is sublimed off at a low temperature under high vacuum. Another possible drying method is spray drying.

Nanopowders modified by way of this method contain between from about 0.1 and about 30 wt. %, and preferably between from about 2 and about 20 wt. %, of the organic modifier.

A particularly preferred oxide hydrate powder as contemplated herein is a boehmite modified with citric acid from Sasol, which is available under the designation Disperal HP 14/7.

All content, subject matter and embodiments that are described for the uses as contemplated herein can also be applied to the washing or cleaning agents described hereafter. Express reference is therefore made at this point to the disclosure provided elsewhere, noting that this disclosure also applies to the washing or cleaning agents as contemplated herein.

A further subject matter as contemplated herein is an enzyme-containing washing or cleaning agent, which is wherein comprising inorganic oxides, hydroxides or oxide hydroxides, and in particular the boehmite modified with citric acid available from Sasol under the designation Disperal HP 14/7. The present enzyme is preferably a protease, in particular a subtilisin, and especially a subtilisin of the BLAP type.

Preferred liquid washing or cleaning agents as contemplated herein comprise, based on the total weight thereof, between from about 0.002 and about 7.0 wt. %, preferably between from about 0.02 and about 6.0 wt. %, and in particular between from about 0.1 and about 5.0 wt. % protease preparations. Washing or cleaning agents that, based on the total weight thereof, comprise between from about 0.2 and about 4.0 wt. % protease preparations are particularly preferred.

Preferred liquid washing or cleaning agents as contemplated herein comprise, based on the total weight thereof, between from about 0.001 and about 5.0 wt. %, preferably between from about 0.01 and about 4.0 wt. %, and in particular between from about 0.05 and about 3.0 wt. % amylase preparations. Liquid washing or cleaning agents that, based on the total weight thereof, comprise between from about 0.07 and about 2.0 wt. % amylase preparations are particularly preferred.

In a preferred embodiment, the enzyme-containing washing or cleaning agent as contemplated herein is a liquid washing agent, and in another preferred embodiment, it is a liquid agent for cleaning hard surfaces, and in particular dishes.

An enzyme within the meaning of the present application shall be understood to mean a protein that performs a certain biocatalytic function. A protease within the meaning of the present application shall be understood to mean an enzyme that catalyzes the hydrolysis of peptide bonds, and thus is able to cleave peptides or proteins.

A protein within the meaning of the present application is a polypeptide that is composed of the natural amino acids, has a substantially linear structure and usually assumes a three-dimensional structure to carry out the function thereof. A peptide is composed of amino acids that are covalently bonded to one another via peptide bonds. The designation polypeptide in this regard clarifies the circumstance that this peptide chain is generally composed of a large number of amino acids, which are linked to one another via peptide bonds. Amino acids can be present in an L or a D configuration, wherein the amino acids of which proteins consist are present in the L configuration. These are referred to as proteinogenic amino acids. In the present application, the proteinogenic, naturally occurring L-amino acids are denoted by the internationally customary 1 and 3 letter codes. Numerous proteins are formed as what are known as pre-proteins, which is to say together with a signal peptide. This shall be understood to mean the N-terminal part of the protein, the function of which usually is to ensure that the formed protein is exported from the producing cell to the periplasm or the surrounding medium and/or that the same is folded correctly. Afterwards, the signal peptide is cleaved from the remainder of the protein under natural conditions by way of a signal peptidase, whereby the same carries out the actual catalytic activity thereof without the initially present N-terminal amino acids. Pro-proteins are inactive precursors of proteins. The precursors thereof comprising a signal sequence are referred to as pre-pro-proteins. For technical applications, the mature peptides, which is to say the enzymes processed after production of the same, are preferred over the pre-proteins.

The proteins can be modified by the cells producing them following the production of the polypeptide chain, for example by the attachment of sugar molecules, formylations, aminations, and the like. Such modifications are referred to as post-translational modifications. These post-translational modifications may, but do not have to, influence the function of the protein.

Proteases, or enzymes in general, can be further developed using various methods, for example, by targeted genetic modification using mutagenesis methods, and optimized for certain usage purposes or with respect to specific properties, for example catalytic activity, stability and the like.

It is furthermore generally known from the prior art that advantageous properties of individual mutations, for example of individual point mutations, can complement one another. A protease that has already been optimized with respect to certain properties, for example with respect to the stability thereof against surfactants and/or other components, can thus additionally be further developed as contemplated herein.

Fragments shall be understood to mean all proteins or peptides that are smaller than natural proteins and, for example, can also be obtained synthetically. Due to the amino acid sequences thereof, they can be assigned to the corresponding complete proteins. For example, they can assume the same structure or proteolytic activities or partial activities, such as the complexing of a substrate. Fragments and deletion variants of starting proteins are very similar, in principle; while fragments represent rather small pieces, the deletion mutants lack only short regions, and thus only individual sub-functions.

Chimeric or hybrid proteins within the meaning of the present application shall be understood to mean proteins having a sequence that comprises the sequences or subsequences of at least two starting proteins. In this regard, the starting proteins can be obtained from different organisms or the same organism. Chimeric or hybrid proteins can be obtained by way of recombination mutagenesis, for example. The purpose of such a recombination can be, for example, to bring about or modify a certain enzymatic function with the aid of the fused-on protein part. It is irrelevant within the meaning a whether such as a chimeric protein is composed of an individual polypeptide chain or several sub-units, among which different functions can be distributed.

Proteins obtained by way of insertion mutation shall be understood to mean those variants which have been obtained by inserting a protein fragment into the starting sequences. They are to be assigned to the chimeric proteins due to the similarity thereof, in principle. They differ from these only in the ratio of the size of the unmodified protein part to the size of the entire protein. In such insertion-mutated proteins, the proportion of foreign protein is lower than in chimeric proteins.

Inversion mutagenesis, which is to say a partial sequence reversal, can be regarded as a special form of both deletion, and of insertion. The same applies to a new grouping of different molecular parts differing from the original amino acid sequence. This can be regarded as a deletion variant, as an insertion variant, and as a shuffling variant of the original protein.

Derivatives, within the meaning of the present application, shall be understood to mean those proteins in which the pure amino acid chain has been chemically modified. Such derivatizations can be carried out, for example, biologically in connection with the protein biosynthesis by the host cell. For this, molecular biological methods can be employed. However, derivatizations can also be carried out chemically, such as by chemically converting a side chain of an amino acid or by covalently bonding a different compound to the protein. Such a compound, for example, can also be other proteins which, for example, are bound to proteins as contemplated herein by way of bifunctional chemical compounds. Such modifications can influence the substrate specificity or the binding strength to the substrate, for example, or cause temporary blocking of the enzymatic activity, if the coupled substance is an inhibitor. This can be useful, for example, for the storage duration. Derivatization shall likewise be understood to mean the covalent bond to a macromolecular carrier, as well as a non-covalent inclusion in suitable macromolecular cage structures.

In a further embodiment as contemplated herein, the enzyme-containing agent is thus characterized in that the enzyme, and preferably the protease, is present in the agent as a fragment, deletion variant, chimeric protein or derivative, wherein the protease furthermore is catalytically active.

Within the meaning as contemplated herein, all enzymes, proteins, fragments, chimeric proteins and derivatives, unless it is necessary to explicitly refer to them as such, are summarized under the generic term “proteins.”

Agents as contemplated herein comprise all types of enzyme-containing agents, and in particular mixtures, recipes, solutions and the like, in which the enzyme stability is improved by the addition of the above-described inorganic oxides, hydroxides or oxide hydroxides. Depending on the field of use, for example, these can be solid mixtures, such as powders comprising freeze-dried or encapsulated proteins, or preferably gel or liquid agents. In particular, these shall be understood to mean agents for the fields of used described hereafter. Further fields of use can be derived from the prior art and are described, for example, in the handbook “Industrial enzymes and their applications” from H. Uhlig, Wiley-Verlag, New York, 1998.

In preferred embodiments as contemplated herein, an agent is characterized by being a washing agent, hand washing agent, rinsing agent, manual dishwashing agent, automatic dishwasher detergent, cleaning agent, dental prosthesis or contact lens care agent, post-rinsing agent, disinfectant, and in particular a laundry detergent or a dishwasher detergent.

This subject matter as contemplated herein includes all conceivable washing or cleaning agent types, both concentrates and agents to be employed undiluted, for use on a commercial scale, in the washing machine or during hand washing or cleaning. This includes, for example, washing agents for textiles, carpets, or natural fibers, for which the term washing agents is used as contemplated herein. This also includes, for example, dishwasher detergents for dishwashers or manual dishwashing agents or cleaners for hard surfaces such as metal, glass, porcelain, ceramic, tiles, stone, painted surfaces, plastic materials, wood or leather; for these, the term cleaning agents is used as contemplated herein.

An agent as contemplated herein can thus represent an agent for large-scale consumers or technical users, and a product for private consumers, wherein all washing and cleaning agent types established in the prior art likewise represent embodiments as contemplated herein.

The washing or cleaning agents as contemplated herein can, in principle, comprise all known ingredients customary in such agents, wherein at least one further ingredient is present in the agent.

The agents as contemplated herein can, in particular, comprise builders, surface-active surfactants, bleaching agents based on organic and/or inorganic peroxygen compounds, bleach activators, water-miscible organic solvents, enzymes, sequestering agents, electrolytes, pH regulators and further auxiliaries, such as optical brighteners, graying inhibitors, foam regulators, dyes and fragrances, and combinations thereof.

The agents as contemplated herein can comprise one or more surfactants, wherein in particular anionic surfactants, non-ionic surfactants, and the mixtures thereof, but also cationic, zwitterionic and amphoteric surfactants may be used.

Suitable non-ionic surfactants are in particular alkylglycosides and ethoxylation and/or propoxylation products of alkylglycosides or linear or branched alcohols, each having 12 to 18 carbon atoms in the alkyl part and 3 to 20, and preferably 4 to 10, alkyl ether groups. Furthermore, corresponding ethoxylation and/or propoxylation products of N-alkyl amines, vicinal diols, fatty acid esters and fatty acid amides, which with respect to the alkyl part correspond to the described long-chain alcohol derivatives, and of alkyl phenols having 5 to 12 carbon atoms in the alkyl functional group may be used.

Alkoxylated, advantageously ethoxylated, in particular primary alcohols having preferably 8 to 18 carbon atoms and on average 1 to 12 moles ethylene oxide (EO) per mole of alcohol, in which the alcohol functional group can be linear or preferably methyl-branched at the 2-position or can comprise linear and methyl-branched functional groups in the mixture, such as those usually present in oxo alcohol functional groups, are preferred as non-ionic surfactants. However, in particular, alcohol ethoxylates comprising linear functional groups of alcohols of native origin having 12 to 18 carbon atoms, for example of coconut, palm, tallow fatty or oleyl alcohol, and an average of 2 to 8 EO per mole of alcohol are preferred. The preferred ethoxylated alcohols include, for example, C12-C14 alcohols having 3 EO or 4 EO, C9-C11 alcohols having 7 EO, C13-C15 alcohols having 3 EO, 5 EO, 7 EO, or 8 EO, C12-C18 alcohols having 3 EO, 5 EO, or 7 EO, and mixtures thereof, such as mixtures of C12-C14 alcohol having 3 EO and C12-C18 alcohol having 7 EO. The degrees of ethoxylation indicated represent statistical averages that can correspond to an integer or a fractional number for a specific product. Preferred alcohol ethoxylates exhibit a restricted distribution of homologs (narrow range ethoxylates, NRE). In addition to these non-ionic surfactants, fatty alcohols having more than 12 EO can also be used. Examples of these are (tallow) fatty alcohols having 14 EO, 16 EO, 20 EO, 25 EO, 30 EO or 40 EO. Extremely low-suds compounds are typically used in particular in agents for use in mechanical processes. These preferably include C12-C18 alkyl polyethylene glycol/polypropylene glycol ethers, each having up to 8 moles ethylene oxide and propylene oxide units in the molecule. It is also possible, however, to use other known low-suds non-ionic surfactants, such as C12-C18 alkyl polyethylene glycol/polybutylene glycol ethers, each having up to 8 moles ethylene oxide and butylene oxide units in the molecule, and end-capped alkyl polyalkylene glycol mixed ethers. Particularly preferred are also the hydroxyl group-comprising alkoxylated alcohols, as they are described in European patent application EP 0 300 305, known as hydroxy mixed ethers. The non-ionic surfactants also include alkyl glycosides of the general formula RO(G)x, where R represents a primary straight-chain or methyl-branched, in particular methyl-branched at the 2-position, aliphatic functional group having 8 to 22, and preferably 12 to 18, carbon atoms, and G denotes a glycose unit having 5 or 6 carbon atoms, and preferably glucose. The degree of oligomerization x, which indicates the distribution of monoglycosides and oligoglycosides, is an arbitrary number, which as a quantity to be analytically determined may also take on fractional values, between 1 and 10; x is preferably 1.2 to 1.4. Polyhydroxy fatty acid amides of formula (III) are likewise suitable, in which R¹CO denotes an aliphatic acyl residue having 6 to 22 carbon atoms, R² denotes hydrogen, an alkyl or hydroxyalkyl functional group having 1 to 4 carbon atoms, and [Z] denotes a linear or branched polyhydroxyalkyl functional group having 3 to 10 carbon atoms and 3 to 10 hydroxyl groups:

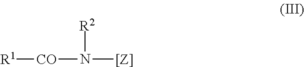

The polyhydroxy fatty acid amides are preferably derived from reducing sugars having 5 or 6 carbon atoms, and in particular from glucose. The group of polyhydroxy fatty acid amides also includes compounds of formula (IV),

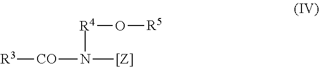

in which R³ denotes a linear or branched alkyl functional group or alkenyl residue having 7 to 12 carbon atoms, R⁴ denotes a linear, branched or cyclic alkylene functional group or an arylene functional group having 2 to 8 carbon atoms, and R⁵ denotes a linear, branched or cyclic alkyl functional group or an aryl functional group or an oxy alkyl functional group having 1 to 8 carbon atoms, wherein C₁-C₄ alkyl or phenyl functional groups are preferred, and [Z] denotes a linear polyhydroxy alkyl functional group, the alkyl chain of which is substituted with at least two hydroxyl groups, or alkoxylated, and preferably ethoxylated or propoxylated, derivatives of this functional group. [Z] is again preferably obtained by the reductive amination of a sugar, such as glucose, fructose, maltose, lactose, galactose, mannose or xylose. The N-alkoxy- or N-aryloxy-substituted compounds can then be converted, for example, in the presence of an alkoxide as the catalyst to the desired polyhydroxy fatty acid amides by reacting these compounds with fatty acid methyl esters. Another class of non-ionic surfactants that is preferably used, which can be used either as the sole non-ionic surfactant or in combination with other non-ionic surfactants, in particular together with alkoxylated fatty alcohols and/or alkyl glycosides, is alkoxylated, preferably ethoxylated or ethoxylated and propoxylated, fatty acid alkyl esters, preferably having 1 to 4 carbon atoms in the alkyl chain, in particular fatty acid methyl esters. Non-ionic surfactants of the amine oxide type, for example N-cocoalkyl-N—N-dimethylamine oxide and N-tallowalkyl-N,N-dihydroxyethylamine oxide, and of the fatty acid alkanolamide type may also be suitable. The quantity of these non-ionic surfactants is preferably no more than that of the ethoxylated fatty alcohols, and in particular no more than half thereof.

Further possible surfactants are those known as gemini surfactants. These are generally understood to mean compounds that comprise two hydrophilic groups per molecule. These groups are generally separated from one another by a so-called “spacer.” This spacer is in general a carbon chain, which should be long enough for the hydrophilic groups to have sufficient distance from one another to be able to act independently of one another. Such surfactants are generally characterized by an unusually low critical micelle concentration and the capability of drastically reducing the surface tension of the water. In exceptions, the expression “gemini surfactants” is understood to mean not only such “dimeric,” but also corresponding “trimeric” surfactants. Suitable gemini surfactants are, for example, sulfated hydroxy mixed ethers or dimer alcohol bis- and trimer alcohol tris-sulfates and -ether sulfates. End-capped dimeric and trimeric mixed ethers are characterized in particular by the bifunctionality and multifunctionality thereof. The above-mentioned end-capped surfactants, for example, exhibit good wetting properties, while being low-suds, whereby they are suitable in particular for use in mechanical washing or cleaning processes. However, it is also possible to use gemini polyhydroxy fatty acid amides or poly-polyhydroxy fatty acid amides. The sulfuric acid monoesters of straight-chain or branched C₇-C₂₁ alcohols ethoxylated with 1 to 6 moles of ethylene oxide, such as 2-methyl-branched C₉-C₁₁ alcohols comprising, on average, 3.5 moles ethylene oxide (EO) or C₁₂-C₁₈ fatty alcohols comprising 1 to 4 EO, are also suited. The preferred anionic surfactants also include the salts of alkyl sulfosuccinic acid, which are also referred to as sulfosuccinates or as sulfosuccinic acid esters and represent monoesters and/or diesters of sulfosuccinic acid with alcohols, preferably fatty alcohols, and in particular ethoxylated fatty alcohols. Preferred sulfosuccinates comprise C₈ to C₁₈ fatty alcohol functional groups or mixtures of these. In particular, preferred sulfosuccinates comprise a fatty alcohol functional group that is derived from ethoxylated fatty alcohols, which taken alone represent non-ionic surfactants. Among these, in turn, sulfosuccinates comprising fatty alcohol functional groups that derive from ethoxylated fatty alcohols exhibiting a restricted distribution of homologs are particularly preferred. Likewise, it is also possible to use alk(en)yl succinic acid having preferably 8 to 18 carbon atoms in the alk(en)yl chain, or the salts thereof. Further possible anionic surfactants are fatty acid derivatives of amino acids, such as of N-methyltaurine (taurides) and/or of N-methylglycine (sarcosides). In particular, the sarcosides or sarcosinates are preferred, and among these especially sarcosinates of higher and optionally monounsaturated or polyunsaturated fatty acids, such as oleyl sarcosinate.

Further anionic surfactants that can also be used are in particular soaps. In particular, saturated fatty acid soaps are suitable, such as the salts of lauric acid, myristic acid, palmitic acid, stearic acid, hydrogenated erucic acid and behenic acid, and in particular soap mixtures derived from natural fatty acids, such as coconut, palm kernel, or tallow fatty acids. Together with these soaps or as a substitute for soaps, it is also possible to use the known alkenyl succinic acid salts.

The anionic surfactants, including the soaps, can be present in the form of the sodium, potassium or ammonium salts thereof, or as soluble salts of organic bases, such as monoethanolamine, diethanolamine or triethanolamine. The anionic surfactants are preferably present in the form of the sodium or potassium salts thereof, and in particular in the form of the sodium salts.

Surfactants are preferably present in the agents as contemplated herein in proportions of from about 5 wt. % to about 50 wt. %, and in particular of from about 8 wt. % to about 30 wt. %.

An agent as contemplated herein preferably contains at least one water-soluble and/or water-insoluble, organic and/or inorganic builder. The water-soluble organic builders include polycarboxylic acids, in particular citric acid and saccharic acids, monomeric and polymeric aminopolycarboxylic acids, in particular methylglycine diacetic acid, nitrilotriacetic acid and ethylenediaminetetraacetic acid and polyaspartic acid, polyphosphonic acids, in particular aminotris(methylenephosphonic acid), ethylenediaminetetrakis(methylenephosphonic acid), and 1-hydroxyethane-1,1-diphosphonic acid, polymeric hydroxy compounds such as dextrin and polymeric (poly-)carboxylic acids, in particular the polycarboxylates accessible by oxidation of polysaccharides or dextrins, polymeric acrylic acids, methacrylic acids, maleic acids, and mixed polymers of the same, which may also have small fractions of polymerizable substances having no carboxylic acid functionality polymerized into the same. The relative molar mass of the homopolymers of unsaturated carboxylic acids is generally between from about 3,000 g/mol and about 200,000 g/mol, that of the copolymers is between from about 2,000 g/mol and about 200,000 g/mol, preferably from about 30,000 g/mol to about 120,000 g/mol, each based on free acid. A particularly preferred acrylic acid/maleic acid copolymer has a relative molar mass of from about 30,000 to about 100,000. Commercially available products are, for example, Sokalan® CP 5, CP 10 and PA 30 from BASF.

Suitable, albeit less preferred compounds of this class are copolymers of acrylic acid or methacrylic acid with vinyl ethers, such as vinyl methyl ethers, vinyl esters, ethylene, propylene and styrene, in which the proportion of the acid is at least about 50 wt. %. It is also possible to use terpolymers comprising two unsaturated acids and/or the salts thereof as the monomers, and vinyl alcohol and/or an esterified vinyl alcohol or a carbohydrate as the third monomer, as water-soluble organic builders. The first acid monomer or the salt thereof is derived from a monoethylenically unsaturated C₃-C₈ carboxylic acid and preferably from a C₃-C₄ monocarboxylic acid, in particular from (meth)acrylic acid. The second acid monomer, or the salt thereof, can be a derivative of a C₄-C₈ dicarboxylic acid, wherein malic acid is particularly preferred, and/or a derivative of an allyl sulfonic acid, which at the 2-position is substituted with an alkyl or aryl functional group. Such polymers in general have a relative molar mass between about 1,000 and about 200,000. Further preferred copolymers are those that preferably contain acrolein and acrylic acid/acrylic acid salts or vinylacetate as monomers. The organic builders can be used in the form of aqueous solutions, and preferably in the form of from about 30 to about 50 percent by weight aqueous solutions, in particular for the production of liquid agents. All aforementioned acids are generally used in the form of the water-soluble salts thereof, in particular the alkali salts thereof.

Such organic builders can be present in amounts of up to about 40 wt. %, in particular up to about 25 wt. %, and preferably from about 1 wt. % to about 8 wt. %, if desired. Amounts close to the aforementioned upper limit are preferably used for pasty or liquid, in particular hydrous, agents as contemplated herein.

In particular, alkali silicates, alkali carbonates and alkali phosphates, which can be present in the form of the alkaline, neutral or acidic sodium or potassium salts, can be used as water-soluble inorganic builder materials. Examples of these include trisodium phosphate, tetrasodium diphosphate, disodium dihydrogen diphosphate, pentasodium triphosphate, so-called sodium hexametaphosphate, oligomeric trisodium phosphate having degrees of oligomerization of from about 5 to about 1000, and in particular from about 5 to about 50, and the corresponding potassium salts or mixtures of sodium and potassium salts. Water-insoluble, water-dispersible inorganic builder materials are, in particular, crystalline or amorphous alkali aluminosilicates, used in amounts of up to about 50 wt. %, preferably not above about 40 wt. % and, in liquid agents, in particular in amounts of from about 1 wt. % to about 5 wt. %. Among these, the crystalline sodium aluminosilicates in washing agent quality, in particular zeolite A, P and optionally X, either alone or in mixtures, for example in the form of a co-crystallizate of the zeolites A and X (Vegobond® AX, a commercial product of Condea Augusta S.p.A.), are preferred. Amounts close to the aforementioned upper limit are preferably used in solid, particulate agents. Suitable aluminosilicates, in particular, comprise no particles having a particle size above about 30 μm, and preferably have a content of at least about 80 wt. % of particles having a size of less than about 10 μm. The calcium binding capacity, which can be determined in accordance with information found in German patent specification DE 24 12 837, is generally in the range of from about 100 to about 200 mg CaO per gram.

Suitable substitutes or partial substitutes for the aforementioned aluminosilicate are crystalline alkali silicates, which can be present alone or in a mixture with amorphous silicates. The alkali silicates that can be used as builders in the agents as contemplated herein preferably have a molar ratio of alkali oxide to SiO₂ of less than about 0.95, in particular of about 1:1.1 to about 1:12 and can be present in amorphous or crystalline form. Preferred alkali silicates are sodium silicates, in particular the amorphous sodium silicates, having a molar ratio of Na₂O: SiO₂ of 1:2 to 1:2.8. Crystalline silicates, which may be present either alone or in a mixture with amorphous silicates, that are used are preferably crystalline phyllosilicates of general formula Na₂SiₓO₂ₓ₋₁.y H₂O, where x, the so-called module, is a number from 1.9 to 22, and in particular 1.9 to 4, and y is a number from 0 to 33, and preferred values for x are 2, 3 or 4. Preferred crystalline phyllosilicates are those in which x in the above-mentioned general formula takes on the value 2 or 3. In particular, both β- and δ-sodium disilicates (Na₂Si₂O₅.y H₂O) are preferred. Practically anhydrous crystalline alkali silicates, produced from amorphous alkali silicates, of the above general formula, in which x denotes a number from 1.9 to 2.1, can also be used in agents as contemplated herein. In a further preferred embodiment of agents as contemplated herein, a crystalline sodium phyllosilicate having a module from about 2 to about 3 is used, as it can be produced from sand and soda. Crystalline sodium silicates having a module in the range from about 1.9 to about 3.5 are used in a further preferred embodiment of agents as contemplated herein. Crystalline phyllosilicates of the above formula (I) are sold by Clariant GmbH under the trade name Na-SKS, such as Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite). Among these, especially Na-SKS-5 (α-Na₂Si₂O₅), Na-SKS-7 (β-Na₂Si₂O₅, natrosilite), Na-SKS-9 (NaHSi₂O₅.3H₂O), Na-SKS-10 (NaHSi₂O₅.3H₂O, kanemite), Na-SKS-11 (t-Na₂Si₂O₅) and Na-SKS-13 (NaHSi₂O₅) are suitable, in particular however Na-SKS-6 (δ-Na₂Si₂O₅). In a preferred embodiment of agents as contemplated herein, a granular compound made of crystalline phyllosilicate and citrate, crystalline phyllosilicate and the above-described (co)polymeric polycarboxylic acid, or alkali silicate and alkali carbonate is used, as it is commercially available under the name Nabion® 15, for example. Builders are preferably present in the agents as contemplated herein in amounts of up to about 75 wt. %, and in particular of from about 5 wt. % to about 50 wt. %.

Possible peroxygen compounds suitable for use in the agents as contemplated herein include, in particular, organic peroxy acids or peracid salts of organic acids, such as phthalimidopercaproic acid, perbenzoic acid, or salts of diperdodecanoic diacid, hydrogen peroxide and inorganic salts giving off hydrogen peroxide under washing conditions, which include perborate, percarbonate, persilicate and/or persulfate such as caroate. To the extent that solid peroxygen compounds are to be used, these may be used in the form of powders or granules, which may also be coated in the manner known per se. If an agent as contemplated herein comprises peroxygen compounds, these are preferably present in amounts of up to about 50 wt. %, and in particular of from about 5 wt. % to about 30 wt. %. The addition of small amounts of known bleaching agent stabilizers, such as phosphonates, borates or metaborates and metasilicates, as well as magnesium salts, such as magnesium sulfate, can be advantageous.

Compounds that, under perhydrolysis conditions, yield aliphatic peroxocarboxylic acids having preferably from about 1 to about 10 carbon atoms, and in particular 2 to 4 carbon atoms, and/or optionally substituted perbenzoic acid, can be used as bleach activators. Suitable substances are those that carry O- and/or N-acyl groups having the described carbon atomic number and/or optionally substituted benzoyl groups. Polyacylated alkylene diamines, in particular tetra acetyl ethylene diamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or iso-nonanoyl oxybenzene sulfonate (n- or iso-NOBS), carboxylic acid anhydrides, in particular phthalic anhydride, acylated polyhydric alcohols, in particular triacetin, ethylene glycol diacetate, 2,5-diacetoxy-2,5-dihydrofuran and enol esters, as well as acetylated sorbitol and mannitol and the described mixtures thereof (SORMAN), acylated sugar derivatives, in particular penta-acetyl glucose (PAG), penta-acetyl fructose, tetra-acetyl xylose and octa-acetyl lactose, as well as acetylated, optionally N-alkylated glucamine and gluconolactone, and/or N-acylated lactams, for example N-benzoyl caprolactam, are preferred. The hydrophilically substituted acyl acetals and the acyl lactams are likewise preferably used. It is also possible to use combinations of conventional bleach activators. Such bleach activators can, in particular in the presence of the above-mentioned hydrogen peroxide-yielding bleaching agents, be present in the customary quantity range, preferably in amounts of from about 0.5 wt. % to about 10 wt. %, and in particular from about 1 wt. % to about 8 wt. %, based on the total agent, but preferably are entirely absent when percarboxylic acid is used as the sole bleaching agent.

In addition to the conventional bleach activators or instead of these, it is also possible for sulfonimines and/or bleach-boosting transition metal salts or transition metal complexes to be present as so-called bleach catalysts.

The organic solvents that can be used, in addition to water, in the agents as contemplated herein, in particular if these are present in liquid or pasty form, include alcohols having 1 to 4 carbon atoms, in particular methanol, ethanol, isopropanol, and tert. butanol, diols having 2 to 4 carbon atoms, in particular ethylene glycol and propylene glycol, and the mixtures thereof and the ethers derivable from the aforementioned compound classes. Such water-miscible solvents are preferably present in the agents as contemplated herein in amounts not above about 30 wt. %, and in particular of from about 6 wt. % to about 20 wt. %.

To set a desired pH value that does not result on its own by virtue of mixing the remaining components, the agents as contemplated herein can comprise system compatible and environmentally compatible acids, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium or alkali hydroxides. Such pH regulators are preferably present in the agents as contemplated herein in amounts not above about 20 wt. %, and in particular of from about 1.2 wt. % to about 17 wt. %.

The task of graying inhibitors is to maintain the dirt dissolved from the textile fibers suspended in the liquor. Water-soluble colloids, usually of an organic nature, are suitable for this purpose, such as starch, glue, gelatin, salts of ether carboxylic acids or ether sulfonic acids of starch or cellulose, or salts of acidic sulfuric acid esters of cellulose or starch. Water-soluble, acidic group-comprising polyamides are also suitable for this purpose. Furthermore, starch derivatives other than those mentioned above may be used, for example aldehyde starches. The use of cellulose ethers, such as carboxymethyl cellulose (Na salt), methyl cellulose, hydroxyalkyl cellulose and mixed ethers, such as methyl hydroxyethyl cellulose, methyl hydroxypropyl cellulose, methyl carboxymethyl cellulose and the mixtures thereof, for example in amounts of from about 0.1 to about 5 wt. %, based on the agents, is preferred.

Textile washing agents as contemplated herein can comprise derivatives of diaminostilbene disulfonic acid or the alkali metal salts thereof, for example, as optical brighteners, although they are preferably free from optical brighteners when used as color washing agents. For example, salts of 4,4′-bis(2-anilino-4-morpholino-1,3.5-triazinyl-6-amino)stilbene-2,2′-disulfonic acid or similarly structured compositions are suitable, which carry a diethanolamino group, a methylamino group, an anilino group or a 2-methoxyethylamino group instead of the morpholino group. Moreover, brighteners of the type of substituted diphenylstyryls can be present, for example the alkali salts of 4,4′-bis(2-sulfostyryl)biphenyl, 4,4′-bis(4-chloro-3-sulfostyryl)biphenyl, or 4-(4-chlorostyryl)-4′-(2-sulfostyryl)biphenyls. It is also possible to use mixtures of the aforementioned optical brighteners.

In particular when used with mechanical processes, it may be advantageous to add customary suds suppressors to the agents. For example, soaps of natural or synthetic origin having a high content of C18-C24 fatty acids are suitable suds suppressors. Suitable non-surfactant-type suds suppressors are, for example, organopolysiloxanes and the mixtures thereof with micro-fine, optionally silanized silicic acid and paraffins, waxes, microcrystalline waxes and the mixtures thereof with silanized silicic acid or bis-fatty acid alkylene diamides. Advantageously, mixtures of different suds suppressors are also used, for example those composed of silicones, paraffins or waxes. The suds suppressors, and in particular silicone-comprising and/or paraffin-comprising suds suppressors, are preferably bound to a granular carrier substance that is soluble or dispersible in water. In particular, mixtures of paraffins and ethylene bis stearamide are preferred.

In further embodiments of agents as contemplated herein, and in particular washing or cleaning agents, the enzymes to be stabilized, preferably proteases, and the inorganic oxides, hydroxides or oxide hydroxides are combined, for example, with individual or multiple of the following ingredients: non-ionic, anionic and/or cationic surfactants, (optionally further) bleaching agents, bleach activators, bleach catalysts, builders and/or co-builders, acids, alkaline substances, hydrotropic substances, solvents, thickeners, sequestering agents, electrolytes, optical brighteners, graying inhibitors, corrosion inhibitors, in particular silver protection agents (silver corrosion inhibitors), disintegration agents, soil release active ingredients, dye transfer (or transfer) inhibitors, suds suppressors, abrasives, dyes, fragrances, perfumes, anti-microbial active ingredients, UV protection agents or absorbers, antistatic agents, pearlescing agents and skin protection agents, further enzymes such as protease, amylase, cellulase, hemicellulase, mannanase, tannase, xylanase, xanthanase, β-glucosidase, carrageenase, oxidase, oxidoreductase, pectin-degrading enzyme or a lipase, further stabilizers, and in particular further enzyme stabilizers, and other components known from the prior art.

In a further embodiment as contemplated herein, an agent as contemplated herein is thus wherein comprising at least one further component selected from the group consisting of surfactants, builders, acids, alkaline substances, hydrotropic substances, solvents, thickeners, bleaching agents, dyes, perfumes, corrosion inhibitors, sequestering agents, electrolytes, optical brighteners, graying inhibitors, silver corrosion inhibitors, dye transfer inhibitors, suds suppressors, disintegration agents, abrasives, UV absorbers, solvents, antistatic agents, pearlescing agents and skin protection agents.

The ingredients to be selected, as well as the conditions under which the agent is used, such as temperature, pH value, ionic strength, redox conditions or mechanical conditions, should be optimized for the particular cleaning problem. Customary temperatures for washing and cleaning agents range from about 10° C. for manual agents, through about 40° C. and about 60° C., to about 95° C. for automatic agents or for technical applications. Since the temperature can usually be continuously varied in modern washing machines and dishwashers, all intermediate stages of the temperature are also covered. The ingredients of the particular agents are preferably matched to one another.

In a further embodiment, an agent as contemplated herein, and in particular a washing or cleaning agent, furthermore comprises:
from about 5 wt. % to about 70 wt. %, and in particular from about 5 wt. % to about 30 wt. % surfactants and/or
from about 10 wt. % to about 65 wt. %, and in particular from about 12 wt. % to about 60 wt. % water-soluble or water-dispersible in particular builder material and/or
from about 0.5 wt. % to about 10 wt. %, and in particular from about 1 wt. % to about 8 wt. % water-soluble organic builders and/or
from about 0.01 to about 15 wt. % solid inorganic and/or organic acids or acid salts and/or
from about 0.01 to about 5 wt. % complexing agents for heavy metals and/or
from about 0.01 to about 5 wt. % graying inhibitors and/or
from about 0.01 to about 5 wt. % dye transfer inhibitors and/or
from about 0.01 to about 5 wt. % suds suppressors.

Optionally, the agent can furthermore comprise optical brighteners, preferably from about 0.01 to about 5 wt. %.

The production of solid agents as contemplated herein does not pose any difficulties and be carried out in the known manner, for example by spray drying or granulation, wherein enzymes and potential further thermally sensitive ingredients, such as bleaching agents, are optionally added separately later. To produce agents as contemplated herein having increased bulk density, in particular in the range from about 650 g/L to about 950 g/L, a method comprising an extrusion step is preferred.

So as to produce agents as contemplated herein in tablet form, which can be single-phase or multiphase, single-color or multi-color and in particular can be composed of one layer or of multiple, in particular of two, layers, the procedure is preferably such that all components—optionally of a respective layer—are mixed with one another in a mixer, and the mixture is compressed using conventional tablet presses, such as eccentric presses or rotary presses, using pressures in the range of approximately from about 50 to about 100 kN, preferably from about 60 to about 70 kN. In particular in the case of multi-layer tablets, it may be advantageous if at least one layer is pre-compressed. This is preferably carried out at pressures between from about 5 and about 20 kN, and in particular at from about 10 to about 15 kN. This readily yields break-resistant tablets that nonetheless dissolve sufficiently quickly under usage conditions, with breaking and flexural strengths of normally from about 100 to about 200 N, preferably however above 150 N. A tablet thus produced preferably has a weight of from about 10 g to about 50 g, and in particular of from about 15 g to about 40 g. The physical shape of the tablets is arbitrary and can be round, oval or angular, intermediate shapes also being possible. Corners and edges are advantageously rounded. Round tablets preferably have a diameter of from about 30 mm to about 40 mm. In particular, the size of angular or cuboid tablets, which are predominantly introduced via the dosing device, for example of the dishwasher, is dependent on the geometry and the volume of this dosing device. Preferred embodiments by way of example have a base area of (from about 20 to about 30 mm)×(from about 34 to about 40 mm), and in particular of about 26×36 mm or of about 24×38 mm.

Liquid or pasty agents as contemplated herein in the form of solutions comprising customary solvents are generally produced by simple mixing of the ingredients, which can be placed into an automatic mixer in substance or as a solution. Embodiments as contemplated hereinthus include all those solid, powdered, liquid, gel or pasty forms of application of the agents which optionally can also consist of multiple phases and can be present in compressed or uncompressed form. Thus, agents that are wherein being present in the form of a monocomponent system represent another embodiment as contemplated herein.

Such agents preferably consist of one phase. Agents as contemplated herein, however, can of course also be composed of multiple phases. In a further embodiment as contemplated herein, the washing or cleaning agent is thus wherein being divided into multiple components.

The solid forms of application as contemplated herein furthermore include extrudates, granules, tablets or pouches, which can be present both in large packages or packaged into portions. As an alternative, the agent is present in the form of a pourable powder, in particular having a bulk density of from about 300 g/L to about 1200 g/L, and in particular from about 500 g/L to about 900 g/L, or from about 600 g/L to about 850 g/L.

In a preferred embodiment as contemplated herein, the washing or cleaning agent is present in liquid, gel or pasty form, and in particular in the form of a non-aqueous liquid washing agent or a non-aqueous paste, or particularly preferably in the form of an aqueous liquid washing agent or a hydrous paste.

The agent as contemplated herein, in particular washing or cleaning agent, can be packaged in a receptacle, preferably an air-permeable receptacle, from which it is released just prior to use or during the washing process.

Agents as contemplated herein can also comprise further proteases or other enzymes in a concentration advantageous for the effectiveness of the agent. Thus, another subject matter as contemplated herein is formed by agents that furthermore comprise one or more further enzymes, wherein, in principle, all enzymes established in the prior art for these purposes can be used. All enzymes that are able to develop a catalytic activity in the agent as contemplated herein can preferably be used as further enzymes, in particular proteases, amylases, cellulases, hemicellulases, mannanases, tannases, xylanases, xanthanases, β-glucosidases, carrageenanases, oxidases, oxidoreductases, pectin-degrading enzymes (pectinases) or lipases, and preferably the mixtures thereof. These enzymes are, in principle, of natural origin; proceeding from the natural molecules, improved variants are available for use in washing and cleaning agents and can be used in correspondingly preferred fashion.

Agents as contemplated herein preferably comprise enzymes in total amounts of from about 1×10-8 to about 5 percent by weight, based on active protein. Preferably from about 0.00001 to about 5 wt. %, more preferably from about 0.0001 to about 2.5 wt. %, still more preferably from about 0.0001 to about 1 wt. %, and particularly preferably from about 0.0001 to about 0.072 wt. % of the enzymes is present in agents as contemplated herein, wherein each enzyme present can be present in the aforementioned quantity ratios

The protein concentration can be determined using known methods, such as the BCA method (bicinchoninic acid; 2,2′-bichinolyl-4,4′-dicarbonic acid) or the biuret method (A. G. Gornall, C. S. Bardawill and M. M. David, J. Biol. Chem., 177 (1948), pp. 751-766). These further enzymes particularly preferably support the action of the agent, for example, the cleaning performance of a washing or cleaning agent, with respect to certain soiling or stains. The enzymes particularly preferably demonstrate synergistic effects regarding the action thereof with respect to certain soiling or stains, which is to say the enzymes present in the agent composition support one another in the cleaning performance thereof. Synergistic effects can occur not only between different enzymes, but also between one or more enzymes and other ingredients of the agent as contemplated herein. In a further preferred embodiment as contemplated herein, the agent as contemplated herein is thus wherein comprising at least one further enzyme, which is a protease, amylase, cellulase, hemicellulase, mannanase, tannase, xylanase, xanthanase, β-glucosidase, carrageenanase, oxidase, oxidoreductase, pectin-degrading enzymes or a lipase.

When comparing the performance of two enzymes, a distinction must be made between equal-protein and equal-activity use. The equal-protein use is recommended in particular in the case of preparations obtained by way of genetic engineering which are substantially free from secondary activities. This allows information to be derived as to whether the same protein amounts, for example as a measure of the yield of fermentative production, yield comparable results. If the respective ratios of active substance to total protein (the values of the specific activity) diverge, an equal-activity comparison is recommended, since this compares the respective enzymatic properties. In general, it applies that a low specific activity can be compensated for by the addition of a relatively large amount of protein. Ultimately, this is an economic consideration.

The protease activity in such agents can be ascertained according to the method described in Tenside (Surfactants), Volume 7 (1970), pp. 125-132. This is correspondingly specified in PE (protease units).

As an alternative, the protease activity can be determined by way of the release of the chromophore para-nitroaniline (pNA) from the substrate suc-L-Ala-L-Ala-L-Pro-L-Phe-p-nitroanilide (AAPF). The protease cleaves the substrate and releases pNA. The release of the pNA causes an increase in the extinction at 410 nm, the temporal progression of which is a measure of the enzymatic activity. The measurement is carried out at a temperature of 25° C., a pH of 8.6 and a wavelength of 410 nm. The measuring time is 5 minutes, and the measuring interval is from about 20 seconds to about 60 seconds.

The enzymes used in the agents as contemplated herein originally come from microorganisms, for example the genus Bacillus, Streptomyces, Humicola or Pseudomonas, and/or are produced according to biotechnology methods that are known per se using suitable microorganisms, for example using transgenic expression hosts of the Bacillus genus or using filamentous fungi.

A further separate subject matter as contemplated herein is a method for cleaning textiles or hard surfaces, in which an enzyme-containing washing or cleaning agent as contemplated herein is active in at least one method step. The method for cleaning textiles or hard surfaces is thus wherein an agent as contemplated herein is used in at least one method step.

These include both manual and mechanical methods, wherein mechanical methods are preferred due to the precise controllability of the same, for example as far as the amounts used and residence times are concerned.

Methods for cleaning textiles are generally wherein, in multiple method steps, different substances providing cleaning action are applied to the product to be cleaned and washed off following the residence time, or that the product to be cleaned is treated in another manner with a washing agent or a solution of this agent. The same applies to methods for cleaning all materials other than textiles, which are combined under the term “hard surfaces.” All conceivable washing or cleaning methods can be enhanced in at least one of the method steps with an agent as contemplated herein and then represent embodiments of the present disclosure.

The enzymes are preferably used in an amount of from about 40 μg to about 4 g, especially of from about 50 μg to about 3 g, particularly preferably of from about 100 μg to about 2 g, and especially particularly preferably of from about 200 μg to about 1 g per application.

A further separate subject matter as contemplated herein is a method for treating textile raw materials or for textile care, in which an enzyme-containing washing or cleaning agent is active in at least one method step.

Among these, methods for textile raw materials, fibers or textiles comprising natural components are preferred, and especially particular for those comprising wool or silk.

These can involve methods, for example, in which materials for processing in textiles are prepared, such as for anti-felting finishing, or, for example, methods that enhance the cleaning of worn textiles with a care component. Given the action described above of proteases on natural, protein-containing raw materials, in preferred embodiments these are methods for treating textile raw materials, fibers or textiles comprising natural components, and in particular comprising wool or silk.

The following examples describe the disclosure in more detail, without limiting it to these examples.

### EXAMPLES

### Example 1: Production of a Boehmite Dispersion

The boehmites used can be commercially available boehmites or boehmites synthesized as described in the prior art.

Example using Disperal HP 14/7 (boehmite modified with citric acid from Sasol):

To produce a dispersion of boehmite as contemplated herein, water is charged and set to a pH of from about 9 to about 10 using a small amount of NH4OH (10%). Thereafter, Disperal HP 14/7 is added in portions while stirring vigorously, and the pH value is set to 7.1 in the process using NH4OH. Subsequently, the dispersion is treated with ultrasound for homogenization.

Comparative example using Disperal HP 14/2 (boehmite modified with HNO3 from Sasol):

To produce a dispersion not as contemplated herein, water is charged. Thereafter, Disperal HP 14/2 is added in portions while stirring vigorously, and the pH value is then set to 7.3 in the process using NH4OH. Subsequently, the dispersion is treated with ultrasound for homogenization.

### Example 2: Immobilization of a Protease

2.5 times the amount of the boehmite suspension described in Example 1 is added to a solution of the protease BLAP R99E (alkaline protease from Bacillus lentus with the substitution R99E, diluted 200 times with distilled water). The boehmites 14/2 and 14/7 are used. The activity of the sample is determined by way of an AAPF activity test (Sample S).

The suspension is shaken for 10 minutes at room temperature in an overhead shaker, and then centrifuged for 15 minutes at 10,600 rpm. The supernatant is separated, and the activity thereof is determined by way of the AAPF test (Sample U).

The pellet is received in 2 times distilled water, resuspended by way of shaking and again centrifuged off, wherein the activities of the suspensions (WSA) and of the supernatants (WUX) are measured again.

After rinsing twice, the pellet is resuspended in 0.1 M glycine/NaOH at various pH values, centrifuged off again, and the activities of the supernatants are determined (pHX).

The following activities were determined:

| | 14/2 (not as contemplated | |
|---|---|---|
| | herein) | 14/7 (as contemplated herein |
| S | 100% | 100% |
| Ü | 88% | 17% |
| WS1 | 8% | 66% |
| WÜ1 | 6% | 0% |
| WS2 | 3% | 52% |
| WÜ2 | 2% | 0% |
| pH 8 | 0% | 27% |
| pH 8.5 | 0% | 24% |
| pH 9 | 0% | 28% |
| pH 9.5 | 0% | 33% |
| pH 10 | 0% | 30% |
| pH 10.5 | 0% | 39% |
| pH 11 | 0% | 41% |

It becomes apparent that the majority of the protease remains in the supernatant in the sample 14/2. The activity (WS) demonstrable in the pellet can also be found in the same order of magnitude in the corresponding supernatant (WÜ), which demonstrates that this is unbound protease remaining in the pellet, which can be removed by the washing step. In the sample 14/7, in contrast, it is apparent that a large portion of the protease remains on the boehmite and is not dissolved from the boehmite even when washed with distilled water.

By resuspension in a 0.1 M glycine/NaOH buffer, however, the protease can be partially released again in the supernatant, wherein higher pH values tend to ensure a stronger release.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. An enzyme-containing washing or cleaning agent comprising inorganic oxides, hydroxides or oxide hydroxides wherein the inorganic oxides, hydroxides or oxide hydroxides are utilized to increase the stability of enzymes.

2. The enzyme-containing washing or cleaning agents according to claim 1, wherein the oxides, hydroxides or oxide hydroxides are selected from the group of oxides, hydroxides or oxide hydroxides of calcium, magnesium, aluminum, titanium, zirconium, yttrium or zinc.

3. The enzyme-containing washing or cleaning agents according to claim 1, wherein the oxides, oxide hydroxides and hydroxides have a particle size of less than about 500 nm.

4. The enzyme-containing washing or cleaning agents according to claim 1, wherein the oxides, oxide hydroxides and hydroxides are surface-modified.

5. The enzyme-containing washing or cleaning agents according to claim 1, wherein the washing or cleaning agent is a liquid washing or cleaning agent.

6. The enzyme-containing washing or cleaning agents according to claim 1, wherein the enzyme is a protease.

7. The enzyme-containing washing or cleaning agents according to claim 1, wherein the inorganic oxide, hydroxide or oxide hydroxide is boehmite.

8. The enzyme-containing washing or cleaning agents according to claim 1, wherein the inorganic oxides, hydroxides or oxide hydroxides are used in amounts of from about 0.01 wt. % about to 5 wt. %.

9. An enzyme-containing washing or cleaning agent, comprising enzymes stabilized by inorganic oxides, hydroxides or oxide hydroxides.

10. The enzyme-containing washing or cleaning agent according to claim 9, wherein the enzyme is a protease.

11. The enzyme-containing washing or cleaning agent according to claim 9, being a liquid washing agent.

12. The enzyme-containing washing or cleaning agent according to claim 9, wherein being a liquid agent for cleaning hard surfaces.

13. The enzyme-containing washing or cleaning agent according to claim 9, comprising inorganic oxides, hydroxides or oxide hydroxides in amounts of from about 0.01 wt. % to about 5 wt. %.

14. A method for cleaning textiles or hard surfaces, the method comprising activating an enzyme-containing washing or cleaning agent according to claim 9 is active.

15. The enzyme-containing washing or cleaning agents according to claim 2, wherein the oxides, hydroxides or oxide hydroxides are selected from the group of oxides, hydroxides or oxide hydroxides of aluminum.

16. The enzyme-containing washing or cleaning agents according to claim 4, wherein the oxides, oxide hydroxides and hydroxides are surface-modified by way of being treated with aqueous solutions of carboxylic acids or hydroxycarboxylic acids having 2 to 8 carbon atoms.

17. The enzyme-containing washing or cleaning agents according to claim 6, wherein the protease is a subtilisin.

18. The enzyme-containing washing or cleaning agents according to claim wherein the boehmite is modified with citric acid.

19. The enzyme-containing washing or cleaning agent according to claim 9, wherein the inorganic oxide, hydroxide or oxide hydroxide is boehmite modified with citric acid.

20. The enzyme-containing washing or cleaning agent according to claim wherein the protease is a subtilisin.
